(19) United States
(12) Patent Application Publication
(10) Pub. No.: US 2007/0234036 A1
(43) Pub. Date: Oct. 4, 2007

(54) Network mobility node authentication

(76) Inventors: Tat Kin Tan, Penang (MY); Lee Booi Lim, Bayan Lepas (MY); Wan Ting Khew, Penang (MY)

Correspondence Address: INTEL CORPORATION;c/o INTELLEVATE, LLC, P.O. BOX 52050, MINNEAPOLIS, MN, 55402, US

(21) Appl. No.: 11/393,022

(22) Filed: Mar. 30, 2006

(51) Int. Cl. H04L 9/00

(52) U.S. Cl. 713/154; 370/252; 713/171; 709/224

(57) ABSTRACT

A router on a home link for a node that couples to the Internet is to authenticate the node. Authentication is to include receiving a connection message from the node. The connection message is to include an identifier for a secure connection between the node and another node, at least a portion of the secure connection routed over the Internet. The router stores the identifier for the secure connection at the router. The router receives another connection message from the node based on the node changing its point of attachment to the Internet. The node's point of attachment is changed from a link that couples the node to the Internet to another link that couples the node to the Internet. The router authenticates the node at the other link based on the other connection message including an identifier that matches the stored identifier for the secure connection between the node and the other node.

### BACKGROUND

In networking environments that include devices or nodes that couple to the Internet, the nodes may move and/or become mobile (e.g., mobile network nodes “MNNs”). In this environment, maintaining a continuous network connection with these MNNs due to that movement is difficult. For example, an MNN that couples to the Internet utilizes Mobile Internet Protocol Version 6 (MIPv6) to communicate with another node that couples to the Internet. In this example, the MNN moves such that its point of attachment to the Internet has changed and is different than its previous point of attachment. A point of attachment, for example, may be a link to an access point node (wired or wireless) for a network that couples to the Internet (e.g. a router). The network that couples to the Internet may include, but is not limited to, wired or wireless local area networks (LAN/WLAN), wide area networks (WAN/WWAN), metropolitan area networks (MAN), personal area networks (PAN) and cellular or wireless broadband telephony networks.

Typically, a network address (e.g., IPv4 or IPv6 address) is associated with the MNN's point of attachment to the Internet. When the MNN's point of attachment changes, another network address is associated with the MNN's new point of attachment to the Internet. This may result in a corresponding change in the MNN's network address. Simply changing the MNN's network address based on a change in the point of attachment may allow the MNN to communicate with another node uninterrupted at the Open Systems Interconnection (OSI) data link layer. However, the MNN may be a mobile handheld or notebook personal computer that has established higher layer connections (e.g., transport and higher levels) with another node. These higher layer connections (e.g., a virtual private network (VPN) connection) may be based on the MNN maintaining a specific network address. Due to authentication requirements, these higher layer connections between the MNN and the node likely cannot be maintained by just changing the network address.

Industry initiatives have tried to address a possible interruption in communications via higher level connections. These initiatives allow an MNN to move from one point of attachment to another without changing the address to which other nodes may forward data to the MNN. Thus, the MNN's network address from the perspective of other nodes has not changed. One such initiative is the Internet Engineering Task Force, Network Working Group, Request for Comments: 3775, Mobility Support in IPv6, published June 2004 (“RFC 3775”). RFC 3775 describes a MIPv6-based communication protocol that allows an MNN to move from one point of attachment to another without changing the network address some or most other nodes may use to communicate with that MNN. This is accomplished by giving the MNN a home address that is associated with its original or initial point of attachment to the Internet. This original or initial point of attachment is typically referred to as the home link. Other nodes will forward communications to a node (e.g., a router) on the home link using that home address associated with the home link. Communications are then forwarded to the MNN by the node on the home link. Thus, as the MNN moves to different points of attachment, that movement is transparent to higher layer connections with other nodes.

Other industry initiatives address instances where an MNN is part of a network that also moves and/or becomes mobile (“mobile network”). One such initiative is the Internet Engineering Task Force, Network Working Group, Request for Comments: 3963, Network Mobility (NEMO) Basic Support Protocol, published January 2005 (“RFC 3963”). RFC 3963 describes a protocol that allows every node coupled to a mobile network to maintain communications with other nodes in or outside of the mobile network while the mobile network moves around and changes its point of attachment to the Internet. The mobile network may couple to the Internet through a node that is also mobile or becomes mobile and has routing capabilities, e.g., a mobile router. In that sense, the mobile network is commonly called a nested network when coupled to another router that is part of another network.

RFC 3963 describes a mobile router as establishing an initial point of attachment to the Internet via a router on a home link. One of the functionalities a router can provide when on a home link is to be a “home agent,” for example, as described in RFC 3963. Data traffic between an MNN in a mobile network and other nodes (“correspondent nodes”) passes through the home agent on the home link and is forwarded to the mobile router's current point of attachment to the Internet (“care-of address”). Thus, the mobility of the mobile router is transparent and/or does not change the point of attachment from the perspective of the nodes that have established connections with the MNN.

### BRIEF DESCRIPTION OF THE DRAWINGS

FIG. 1A is an example illustration of secure communication for a mobile network node at a location in a system with a secure connection routed over the Internet to another node;

FIG. 1B is an example illustration of secure communication for a mobile network node at another location in the system with the secure connection routed over the Internet to the other node;

FIG. 2A is an example illustration of secure communication for a mobile network node in a nested mobile network in a system with a secure connection routed over the Internet to another node;

FIG. 2B is an example illustration of the nested mobile network moving to another domain and maintaining the secure connection to the other node;

FIG. 3 is a block diagram of an example authentication manager architecture;

FIG. 4 is a block diagram of an example connection manager architecture;

FIG. 5 is a flow chart of an example method to authenticate a mobile network node; and

FIG. 6 is a flow chart of an example method to authenticate the mobile network node to a router.

### DETAILED DESCRIPTION

As mentioned in the background, industry initiatives describe ways an MNN and a mobile network may remain mobile without changing their home address and thus move transparently to most other nodes. This freedom to move transparently may increase the risk that sensitive or private information may be accessed, modified, or intercepted by an unauthorized party. These problems are typically mitigated or reduced by setting up or establishing a secure connection between two nodes that wish to communicate. In some instances this secure connection may include at least a portion of the secure connection routed over the Internet.

One industry initiative that describes a way to establish secure connections that are at least partially routed over the Internet is an initiative by the Internet Engineering Task Force, Network Working Group, Request for Comments: 2401, Security Architecture for the Internet Protocol, published November 1998 (“IPSec”). Another way to establish these types of secure connections is via use of Public Key Infrastructure (PKI). Use of PKI to establish a secure connection may follow at least portions of one or more industry initiatives related to PKI. One such initiative is the Internet Engineering Task Force, Network Working Group, Request for Comments: 4210, Internet X.509 Public Key Infrastructure Certificate Management Protocol, published September 2005 (“RFC 4210”), although this disclosure is not limited to only this PKI related RFC. Both ways of establishing a secure connection (IPSec or PKI) implement authentication procedures to ensure each node and/or router on a secure connection is the intended recipient of a communication and not a rogue or unauthorized party. These authentication procedures typically take several steps to perform and may use a fair amount of node and/or router resources to implement.

Typically when implementing either IPSec or PKI, each time an MNN changes its point of attachment (e.g., MNN moves or the mobile network moves), the MNN completes authentication procedures to maintain a previously established secure connection with another node. However, when an MNN or mobile network changes its point of attachment on a relatively frequent basis (e.g., several times in a few minutes), multi-step authentication procedures may take too long and use excessive amounts of node resources to implement. This may slow and degrade the overall performance of the MNN and the other node wishing to communicate to the MNN via the secure connection.

In one example, a router on a home link for a node (e.g., an MNN) that couples to the Internet, implements a method to authenticate the node. The method to include receiving a s connection message from the node, the connection message to include an identifier for a secure connection between the node and another node. At least a portion of the secure connection between the MNN and the node is routed over the Internet. The identifier is stored at the router. The router receives another connection message from the node based on the node changing its point of attachment to the Internet. The node's point of attachment changed from a link that couples the node to the Internet to another link that couples the node to the Internet. The node is authenticated at the other link based on the other connection message including an identifier matching the stored identifier for the secure connection between the node and the other node.

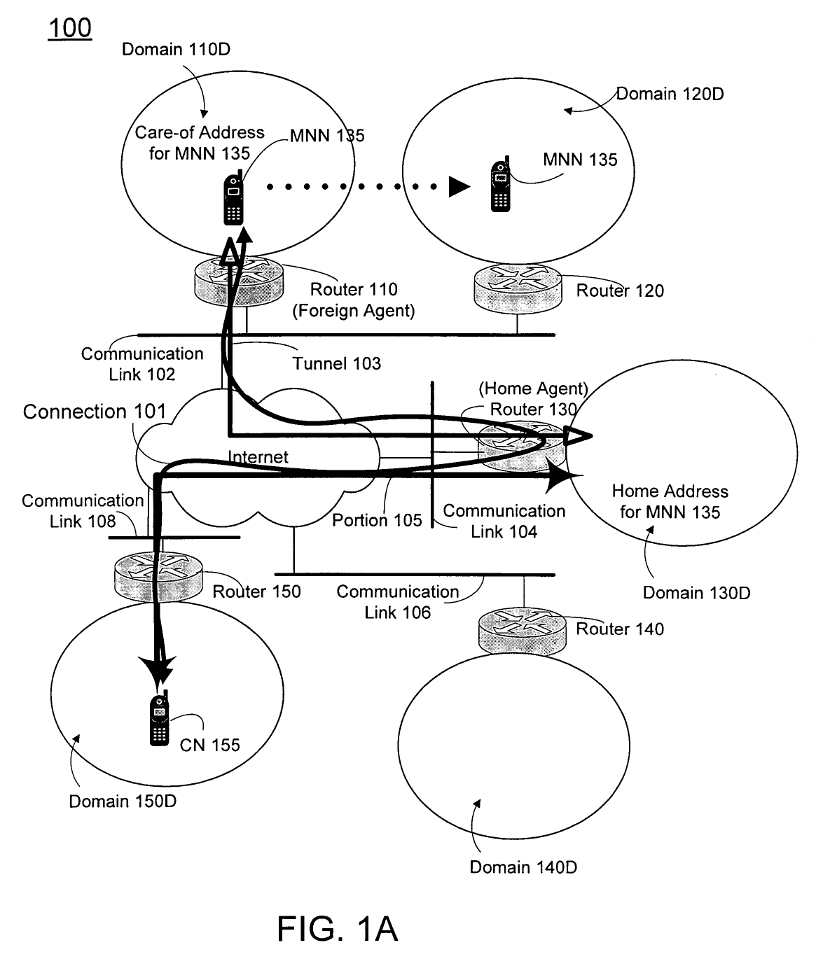

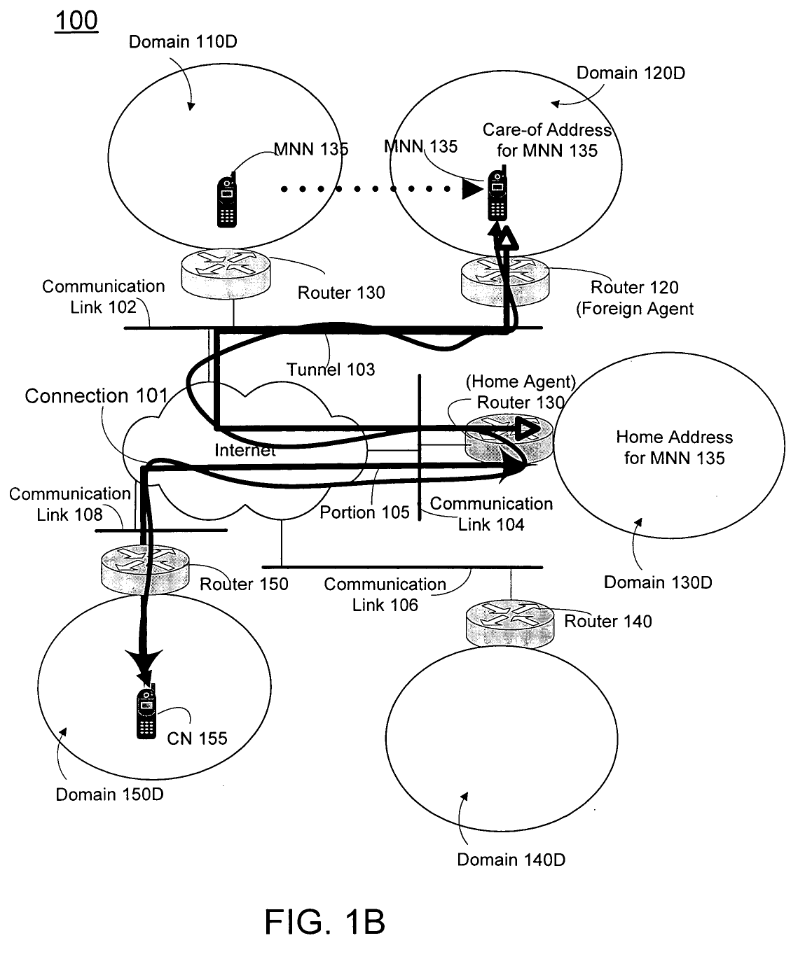

FIG. 1A is an example illustration of secure communication for a mobile network node 135 at a location in system 100 with a secure connection 103 routed over the Internet to a correspondent node 155. As depicted in FIG. 1A, system 100 includes communication links 102, 104 and 106 coupled to the Internet. These communication links, for example, include but are not limited to the wired and/or wireless pathways via which devices or nodes couple to the Internet. In one example, communication links 102, 104 and 106 are each part of a given network or a combination of given networks that couple to the Internet. For example, these networks include, by are not limited to, wired/wireless LANs, WANs, MANs or PANs.

Although FIG. 1 depicts routers and telephony devices, nodes also include, but are not limited to, access points, two-way radio communication systems, one-way pagers, two-way pagers, personal communication systems, personal computers, personal digital assistants (PDAs), digital broadband telephony devices, portable music, video or game players and computing devices.

As shown in FIG. 1A, routers 110 and 120 couple to the Internet via communication link 102 and routers 130, 140 and 150 couple to the Internet via communication links 104, 106 and 108, respectively. In one example, the routers 110, 120, 130, 140 and 150 are associated with domains 110D, 120D, 130D, 140D and 150D, respectively. In this example, domain 110D, 120D, 130D, 140D and 150D indicate, via a network address, a point of attachment that couples a node to the Internet. As a result, in this example, a network address associated with domain 110D would indicate a point of attachment at router 110.

In one implementation, the nodes in system 100 operate consistent with RFC 3775 and RFC 3963. In one example of this implementation, a mobile network node (MNN) 135 has an original or initial point of attachment via router 130. Thus, MNN 135's home link is via router 130 and its home address is a network address associated with domain 130D. Router 130, in this example, by virtue of its home link status, is the home agent for MNN 135.

As depicted in FIG. 1A, MNN 135 is currently located within domain 110D and has a point of attachment via router 110. According to RFC 3963, this point of attachment, by virtue of being different than its home link via router 130, is identified as a foreign link and the network address associated with domain 110D, while MNN 135 is located in that domain, is MNN 135's care-of address. This care-of address is used by router 130 to route or forward communications destined for MNN 135.

In one example, MNN 135 wishes to communicate via a secure connection to another node that is referred to as a correspondent node. Following RFC 3775 and RFC 3963, MNN 135 uses MIPv6 communication protocols to communicate with other nodes in system 100, although this disclosure is not limited to only MIPv6 communication protocols, but may include other types of IP communication protocols (e.g., MIPv4) described in other industry initiatives or standards. In this example, the correspondent node is depicted in FIG. 1A as CN 155. In other implementations, the correspondent node may be any node coupled to communication links 102, 104, 106 or 108. As shown in FIG. 1A, CN 155 has a point of attachment via router 150 and has a network address within domain 150D. The secure connection between MNN 135 and CN 155 is portrayed as connection 101 in FIG. 1A.

In one example, to establish connection 101 between MNN 135 and CN 155, IPSec procedures are implemented as described in RFC 3775. In this IPSec implementation, MNN 135 and CN 155 initiate connection 101 by exchanging data in the form of security policies that are part of a security association database (SAD). The SAD may contain, for instance, a list of encryption standards (e.g., Advanced Encryption Standard (AES), Data Encryption Standard (DES), Triple Data Encryption Standard (3DES), etc.) that are used with various encryption algorithms (e.g., Cipher Block Chaining (CBC), Counter Mode Encryption with CBC to Media Access Controller (MAC) authentication (CCM), Electronic Code Book (ECB), etc.). Connection 101, for example, is established once MNN 135 and CN 155 synchronize each other's SAD to agree on which encryption algorithm is to be used with each encryption standard and then use the synchronized SADs in a mode of operation to maintain a secure communications, e.g., encrypt/decrypt communications between the nodes.

In one implementation, establishing connection 101 also includes setting up a bi-directional tunnel consistent with RFC 3775 and RFC 3963. Thus, in one example, connection 101 includes a bi-directional tunnel that is shown in FIG. 1A as tunnel 103. Tunnel 103 has end points at MNN 135's home link—router 130 and at its foreign link—router 110. In this implementation, a series of steps were taken by MNN 135, router 110 and router 130 (e.g., registration, binding updates, binding update acknowledgements, etc.) to set-up tunnel 103.

In one example, once tunnel 103 is set-up, communication in the form of data packets is forwarded between MNN 135 and CN 155 via connection 101. For example, the data packets are first forwarded to MNN 135's home agent (router 130) via a portion of connection 101 that is routed over the Internet. This Internet portion of connection 101 is depicted in FIG. 1A as portion 105. The data packets are then tunneled via tunnel 103 to MNN 135's foreign agent—router 110.

In one example, the synchronized SADs between CN 155 and MNN 135, are used to encrypt and decrypt exchanged data packets and thus provide security for the data packets as they pass through portion 105. In addition, tunnel 103 provides added security to the encrypted data packets to make sure they reach MNN 135, the intended destination.

In another example, connection 101 may be secured via PKI. In this example, both MNN 135 and CN 155 may register with an authority (not shown) to provide PKI services. For example, following RFC 4210. In one example, the authority is on a network that couples to the Internet. MNN 135 and CN 155 may use the PKI services to authenticate each other and exchange a secret key for symmetric encryption of data packets forwarded or exchanged between the nodes. The symmetric encryption to maintain the secure connection between the nodes

In one implementation, MNN 135's home agent—router 130, may maintain a secure connection database (e.g., in a resident memory) for MNN 135. This database, for example, includes information related to a secure connection that MNN 135 has established (e.g., connection 101) with another node (e.g., CN 155). As described more below, this secure connection may have an identifier for that connection that is received from MNN 135 once the connection is established (e.g., via PKI or IPSec). The identifier, for example, is received in a connection message from MNN 135.

In one example, MNN 135 moves to a location that places it within domain 120D as depicted in FIG. 1B. As a result, MNN 135 changes its point of attachment from router 110 to router 120. This changes MNN 135's foreign agent to router 120 and its care—of address to a network address within domain 120D.

In one implementation, consistent with RFC 3775 and RFC 3963, a bidirectional tunnel is set-up. This bi-directional tunnel is portrayed in FIG. 1B as tunnel 107. Tunnel 107, for example, is set-up to tunnel communications (e.g., data packets) from MNN 135's home agent—router 130, to MNN 135. As a result, tunnel 107 has end points at router 130, and at its new foreign agent—router 120. Thus, connection 101 between MNN 135 and CN 155 now includes portion 105 and the new tunnel 107. Since MNN 135 no longer uses router 110 as a point of attachment to the Internet, tunnel 103, as shown in FIG. 1A, is no longer part of connection 101.

In one implementation, based on the change in point of attachment for MNN 135 to the Internet from router 110 to router 120, MNN 135 sends another connection message to router 120. This connection message includes the identifier assigned to or associated with connection 101 when it was first established between MNN 135 and CN 155. Router 120 compares the identifier to the identifier for connection 101 maintained in its connection database. If the identifiers match, MNN 135 is authenticated or confirmed to be the same MNN 135 that was at the previous point of attachment via router 110.

In one example, MNN 135's use of a connection identifier enables router 130 to quickly authenticate MNN 135 without going through the numerous authentication steps in an IPSec authentication scheme as described in RFC 3775 or RFC 3963 for a home agent or as required in a PKI authentication. Since MNN 135's home agent masks MNN 135's movement from link to link, CN 155 does not have to re-authenticate MNN 135 each time it moves. Thus, it continues to use either IPSec or PKI to maintain a secure connection with MNN 135.

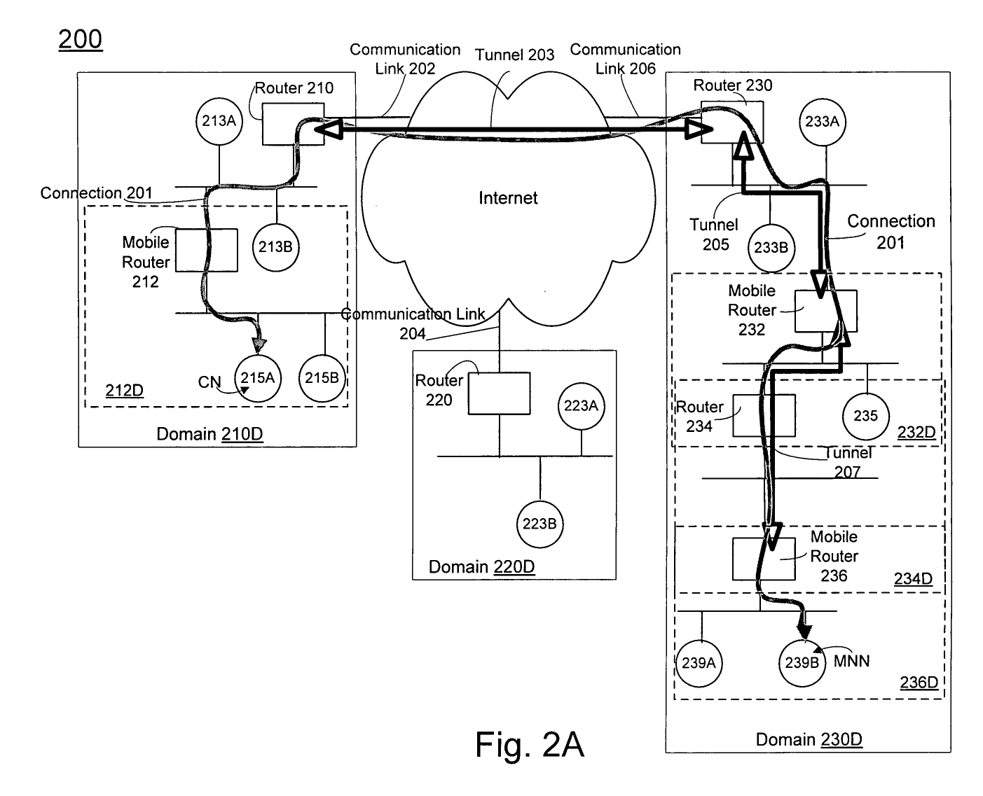

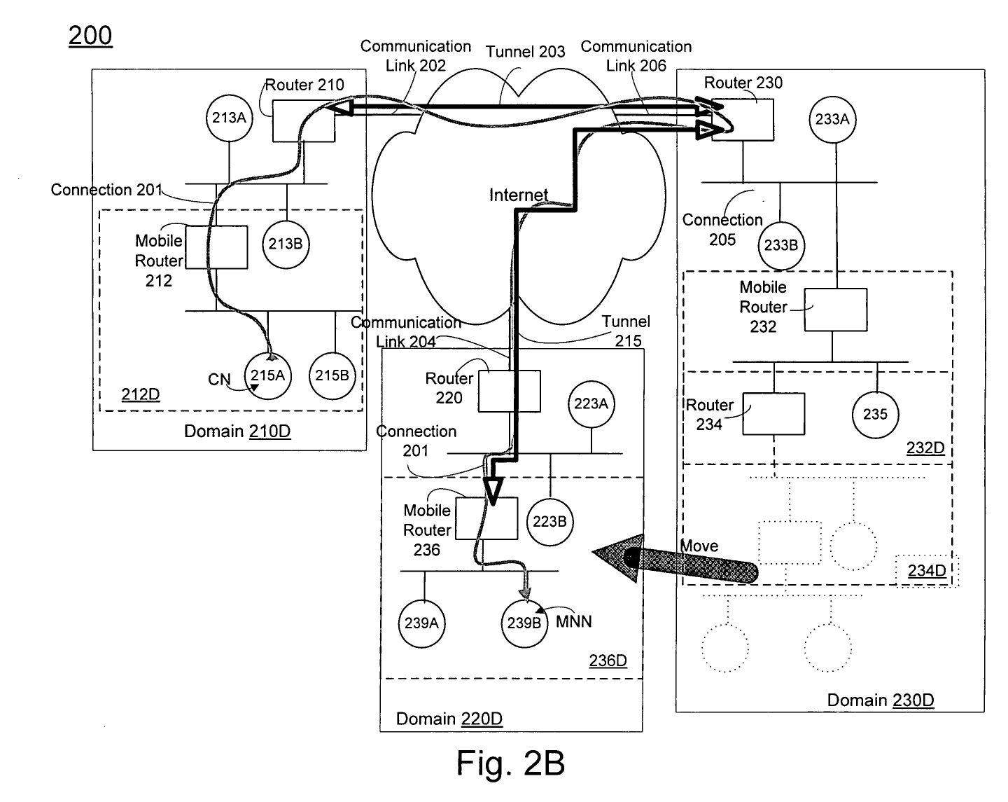

FIG. 2A is an example illustration of secure communication for MNN 239B in a nested mobile network 234D in system 200 with a secure connection routed over the Internet to CN 215A in a nested mobile network 212D. As shown in FIG. 2B, several different domains exist in system 200. Domain 210D includes a nested mobile network 212D that couples to the Internet via router 210 on communication link 202. Domain 220D, depicted as a dashed-line box in FIG. 2A, includes router 220 that couples to the Internet via router 220 on communication link 204. Domain 230D includes nested mobile networks 232D, 234D and 236D, each depicted as a dashed-line box in FIG. 2A. Each of these nested networks in domain 230D, for example, couple to the Internet via router 230 on communication link 206.

In one implementation, each node located in domains 210D, 220D and 230D are either fixed, stationary or mobile and may have routing capabilities, e.g., ability to serve as a point of attachment to the Internet for other nodes and/or forward communications to/from coupled nodes. In FIG. 2A, nodes with routing capabilities are shown in FIG. 2B as rectangles and are labeled as routers. With the exception of CN 215A and MNN 239B, nodes without routing capabilities or having no nodes using the router as a point of attachment, are shown as circles and are labeled only with numbers.

In one example, routers that are mobile or become mobile may be mobile routers. Thus, as depicted in FIG. 2B, in one example, routers 212, 232 and 236 are denoted as mobile routers. Similar to MNN 135, as described for FIG. 1A and FIG. 1B, a mobile router that operates consistent with RFC 3963 has a home agent, home link and home address. As portrayed in FIG. 2A, router 230 is on the home link for mobile routers 232 and 236. These mobile routers will have their home address associated with domain 230D and router 230 is their home agent. Also, router 210 is on the home link for mobile router 212. Mobile router 212 will have its home address associated with domain 210D and router 210 is its home agent.

In one implementation, MNN 239B has established a secure connection with CN 215A (e.g., via IPSec or PKI). This secure connection is portrayed in FIG. 2A as connection 201. Connection 201 also includes a series of bi-directional tunnels shown as tunnels 203, 205, and 207. Tunnels 203, 205 and 207 have endpoints at mobile routers 234 and 236 and at routers 210 and 220 on the home link for domains 210D and 230D. These bi-directional tunnels, for example, are set-up as described in RFC 3775 and RFC 3963

In one implementation, following the establishment of connection 201 between MNN 239B and CN 215A, MNN 239B associates an identifier with connection 201. This identifier may be a unique or truly random number generated by MNN 239B. MNN 239B then generates a connection message that includes the identifier. The connection message is forwarded to mobile router 236. In one example, the connection message is then routed from mobile router 236 to mobile router 236's home agent on its home link to the Internet. This home agent, as mentioned above, is router 230. Router 230 then adds the identifier for the connection 201 to a connection database. This database to be maintained or stored by router 230, e.g., in a memory resident on or responsive to router 230 (not shown).

In one example, the identifier for connection 201, received in the connection message from MNN 239B, is used by router 230 to authenticate MNN 239B. This authentication to occur should either MNN 239B or one of MNN 239B's mobile routers change their point of attachment to the Internet.

In one implementation, mobile router 236 moves to a location that places it within domain 220D as depicted in FIG. 2B. As a result, mobile router 236 changes its point of attachment to the Internet from router 230 to router 220. Since MNN 239B is part of mobile router 236's nested network, its point of attachment is changed as well. This movement of mobile router 236 makes router 220 its foreign agent and its care-of address is now a network address within domain 220D. Consistent with RFC 3775 and RFC 3963, a bi-directional tunnel is set-up to tunnel communications (e.g., data packets) to mobile router 236's home agent, router 230. As shown in FIG. 2B, this bi-directional tunnel is tunnel 215 with end points at router 236 and router 230.

In one example, since only mobile router 236 has moved, tunnel 203 is maintained between routers 230 and 210. As depicted in FIG. 2B, connection 201 between MNN 239B and CN 215A now includes tunnels 215 and 203. Tunnels 207 and 205 are no longer part of connection 201.

In one implementation, based on the change in point of attachment for MNN 239B to the Internet, MNN 239B generates and forwards another connection message to router 236. This other connection message includes the identifier assigned to or associated with connection 201 when it was first established between MNN 239B and CN 215A. Router 236 forwards the connection message to router 230. Router 230 receives the connection message and compares the identifier to the identifier for connection 201 maintained in its connection database. If the identifiers match, MNN 239B is authenticated or confirmed to be the same MNN 239B that was at the previous point of attachment when it was located in a nested network in domain 230D.

In one example, similar to what was described above for MNN 135, MNN 239B's use of a connection identifier enables router 230 to quickly authenticate MNN 239B without going through numerous authentication steps. Since MNN 239B's home agent masks MNN 239B and its associated mobile router 236's movement from foreign link to foreign link, CN 215A does not have to re-authenticate MNN 239B each time it moves.

In one implementation, portions of system 200 may be elements of one or more city-wide networks that are dispersed throughout a city or metropolitan area. For example, routers 210, 220 and 230 may be access point nodes. These routers may be located at fixed locations such as train or bus stations in the city. In this regard, communication links 202, 204 and 206 may be broadband wired or wireless communication links to couple nodes on a city-wide network(s) to the Internet. In addition, nested networks attached to these routers may also serve as point of attachments for nodes to couple to the Internet. Communications between nodes may be routed through connections having at least a portion routed over the Internet, for example, as portrayed in FIG. 2A and FIG. 2B.

In one example, router 230 and its associated domain 230D may serve as the point of attachment to the Internet for a metropolitan train system via router 230's communication link 206. In this example, mobile router 232 may be a wireless router located on a train in the metropolitan train system and located within domain 230D. Thus mobile router 232 has an associated nested mobile network of domain 232D. The train cars attached to this train may each include routers that couple to mobile router 232 and are within domain 232D. For example, router 234 is located in a train car on this train and thus is part of domain 232D.

In one example, mobile router 236 may be a notebook personal computer with routing capabilities. For example, a person can use the notebook personal computer to couple other nodes (e.g., a PDA, phone, portable music player, etc.) to the Internet. This is accomplished through mobile router 236's connection to other routers within domain 230D. For example, nodes 239A and 239B are part of mobile router 236's nested mobile network and have network addresses associated with domain 236D.

In one example, MNN 239B may be a person's PDA whose point of attachment to the Internet starts at mobile router 236 (the person's notebook personal computer). For example, the person's PDA has established connection 201 with a corporate server at the person's place of employment (e.g., via IPSec or PKI). That server, for example, is CN 215A in domain 210D. In this example, the person boarded the train and then established connection 201 as depicted in FIG. 2A while on board the train. Thus, router 230 becomes mobile router 236's and correspondingly MNN 239B's home agent.

That person may subsequently leave the train and enter a coffee shop. This coffee shop may include router 220 that couples to the Internet via communication link 204. Thus as depicted in FIG. 1A, mobile router 236 has moved within domain 220D. As described above, new bidirectional tunnels are set-up and MNN 239B is authenticated by router 230 to maintain the secure connection between MNN 239B and CN 215A.

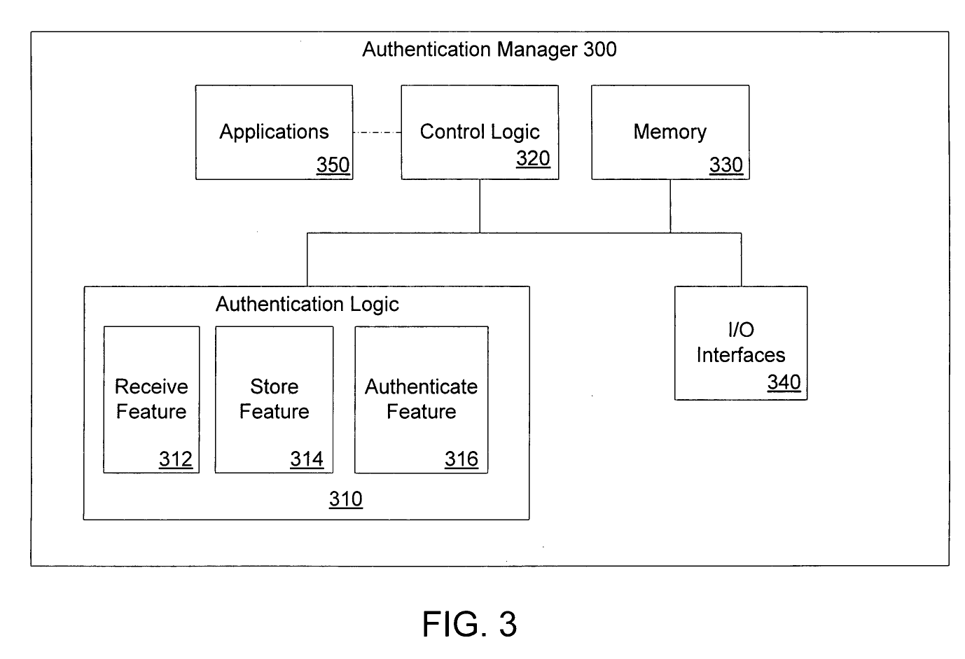

FIG. 3 is a block diagram of an example authentication manager 300 architecture. In FIG. 3, authentication manager 300 includes authentication logic 310, control logic 320, memory 330, input/output (I/O) interfaces 340 and optionally one or more applications 350, each coupled as depicted. Authentication manager 300, in one example, is located within or responsive to a router on a home link for a node that couples to the Internet (e.g., router 130 or router 230).

In one example, the elements portrayed in FIG. 3's block diagram are node or router resources allocated to support or enable an authentication manager 300 as described in this disclosure. For example, authentication logic 310 and control logic 320 each or collectively represent any of a wide variety of logic device(s) or executable content a router allocates to implement an authentication manager 300. These logic device(s) may include a microprocessor, network processor, service processor, microcontroller, field programmable gate array (FPGA), application specific integrated circuit (ASIC), or executable content to implement such control features, or any combination thereof.

In FIG. 3, authentication logic 310 includes receive feature 312, store feature 314 and authenticate feature 316. In one implementation, authentication logic 310 uses these features to receive a connection message from a node that includes an identifier for a connection between the node and another node, stores the identifier and authenticates the node based on the stored identifier matching another identifier included in another connection message received from the node.

Control logic 320 may control the overall operation of authentication manager 300 and as mentioned above, may represent any of a wide variety of logic device(s) or executable content to implement the control of authentication manager 300. In alternate examples, the features and functionality of control logic 320 are implemented within authentication logic 310.

According to one example, memory 330 is used by authentication logic 310 or control logic 320 to temporarily store information. For example, a connection database for maintaining information such as connection identifiers for connections between nodes. Memory 330 may also store executable content. The executable content may be used by control logic 320 and/or authentication logic 310 to implement or activate features or elements of authentication manager 300.

I/O interfaces 340 may provide an interface via a communication medium or link between authentication manager 300 and elements resident on a router or located remotely to the router (e.g., network administrator, network manager, etc.). As a result, I/O interfaces 340 may enable authentication logic 310 or control logic 320 to receive a series of instructions from these elements. The series of instructions may activate authentication logic 310 and/or control logic 320 to implement one or more features of authentication manager 300.

In one example, authentication manager 300 includes one or more applications 350 to provide internal instructions to control logic 320. Such applications 350 may be activated to generate a user interface, e.g., a graphical user interface (GUI), to enable administrative features, and the like. For example, a GUI provides a user access to memory 330 to modify or update information that authentication manager 300 uses to authenticate nodes.

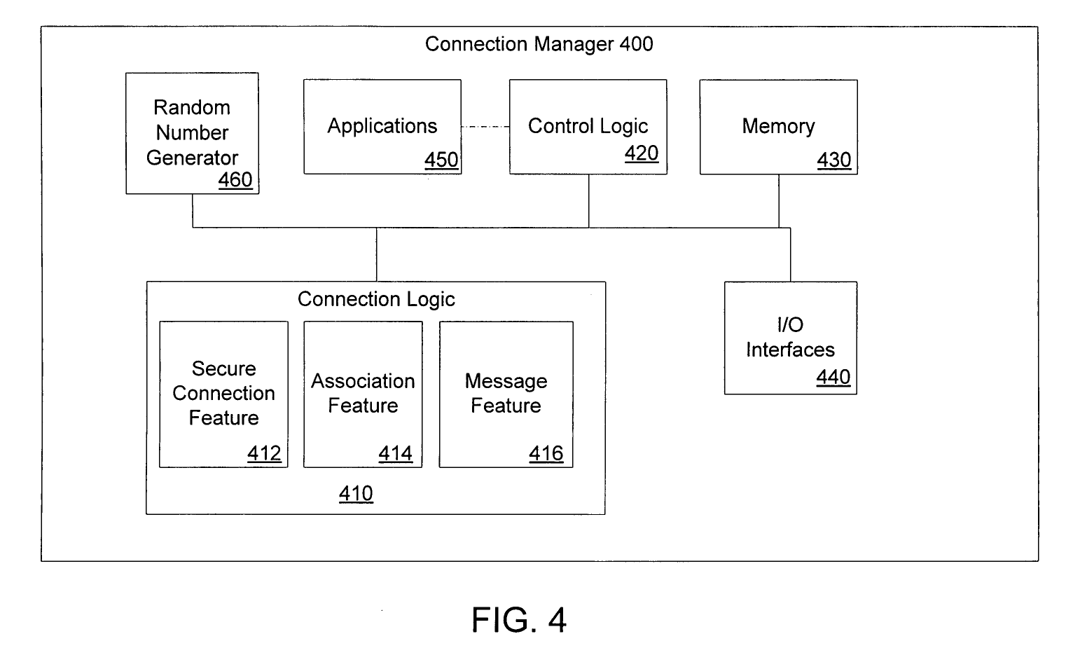

FIG. 4 is a block diagram of an example connection manager 400 architecture. In FIG. 4, connection manager 400 includes connection logic 410, control logic 420, memory 430, input/output (I/O) interfaces 440, optionally one or more applications 450 and a random number generator 460, each coupled as depicted. Connection manager 400, in one example, is located within or responsive to a node that couples to the Internet (e.g., any nodes depicted in FIG. 1A/B or FIG. 2A/B).

In one example, the elements portrayed in FIG. 4's block diagram are node resources allocated to support or enable a connection manager 400 as described in this disclosure. For example, connection logic 410 and control logic 420 each or collectively represent any of a wide variety of logic device(s) or executable content a node allocates to implement a connection manager 400. These logic device(s) may include a microprocessor, network processor, service processor, microcontroller, FPGA, ASIC, or executable content to implement such control features, or any combination thereof.

In FIG. 4, connection logic 410 includes secure connection feature 412, association feature 414 and message feature 416. In one implementation, connection logic 410 uses these features to establish a secure connection between a node and another node, associate an identifier with that connection and forward connection messages that include the identifier to a router on a home link for the node. The identifier in the connection message to be used by the router to authenticate the node.

Control logic 420 may control the overall operation of connection manager 400 and as mentioned above, may represent any of a wide variety of logic device(s) or executable content to implement the control of connection manager 400. In alternate examples, the features and functionality of control logic 420 are implemented within connection logic 410.

According to one example, memory 430 is used by connection logic 410 or control logic 420 to temporarily store information. For example, an identifier assigned or associated with a connection established between nodes or information related to a secure connection between a node and another node (e.g., SADs, PKI information, etc.) Memory 430 may also store executable content. The executable content may be used by control logic 420 and/or connection logic 410 to implement or activate features or elements of connection manager 400.

I/O Interfaces 440 may provide an interface via a communication medium or link between connection manager 400 and elements resident on a node or located remotely to the node (e.g., network administrator, network manager, etc.). As a result, I/O interfaces 440 may enable configuration logic 410 or control logic 420 to receive a series of instructions from these elements. The series of instructions may activate connection logic 410 and/or control logic 420 to implement one or more features of connection manager 400.

In one example, connection manager 400 includes one or more applications 450 to provide internal instructions to control logic 420. Such applications 450 may be activated to generate a user interface, e.g., a graphical user interface (GUI), to enable administrative features, and the like. For example, a GUI provides a user access to memory 430 to modify or update information that connection manager 400 uses to establish and maintain a secure connection between nodes.

In one example, connection manager 400 includes random number generator 460. Random number generator 460, for example, generates random numbers. In one implementation, each random number is 32-bits in size and is used by association feature 414 in connection logic 410. For example, association feature 414 uses a given 32-bit random number as an identifier and associates that identifier with a connection between nodes (e.g., connection 101 or connection 201).

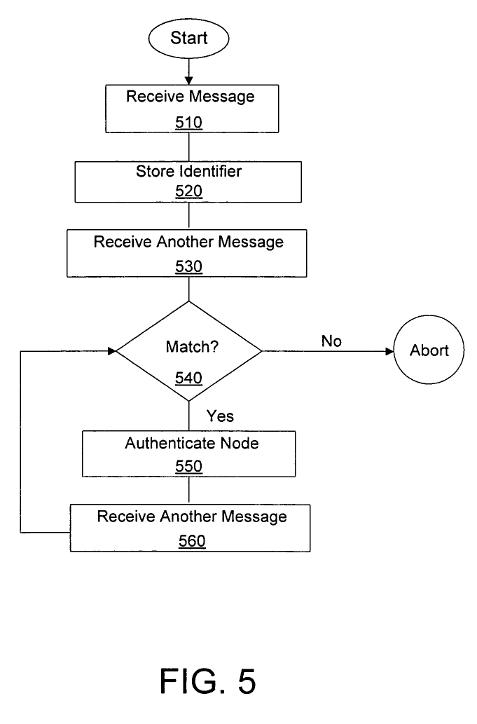

FIG. 5 is a flow chart of an example method to authenticate MNN 135 at router 130 as portrayed in FIGS. 1A and 1B. In one example, the method begins with MNN 135 located within domain 110D. Thus, MNN 135 has a point of attachment to the Internet via router 110 on communication link 102. In this example method, as described above, MNN 135 has established a secure connection with CN 155 via connection 101 and has associated an identifier with that connection.

In block 510, in one example, authentication logic 310 of authentication manager 300 in router 130 activates receive feature 312. Receive feature 312, in one implementation, receives a connection message from MNN 135 that includes the identifier for connection 101.

In block 520, in one example, authentication logic 310 activates store feature 314 to at least temporarily store the identifier for connection 101 in a connection database. This connection database, for example, may be in a memory resident on or responsive to router 130 (e.g., memory 330).

In block 530, in one example, receive feature 312 receives another connection message from MNN 135. This other connection message received based on MNN 135 changing its point of attachment. For example, as shown in FIG. 1B, MNN 135 moves such that its point of attachment changes to router 120. The other connection message, in this example, includes an identifier for connection 101.

In block 540, in one example, authentication logic 310 activates authenticate feature 316. Authenticate feature 316 obtains the identifier for connection 101 that was stored by store feature 314 and also obtains the identifier in the other connection message. Authenticate feature 316 compares the two identifiers. If the identifiers do not match, MNN 135 is not authenticated. The authentication of MNN 135 via use of a connection identifier is aborted. This may require MNN 135 or router 130 to initiate other authentication procedures (e.g., PKI authentication steps).

In block 550, in one example, MNN 135 is authenticated by router 130 and connection 101 is maintained between MNN 135 and CN 155.

In block 560, in one example, router 130 receives another connection message from MNN 135. This other message may be based on MNN 135 moving again and changing its point of attachment. If this occurs, the method moves to block 540.

The process may start over if another connection is established between MNN 135 and another node in system 100 and MNN 135 sends a connection message for that new connection that includes an identifier for the connection.

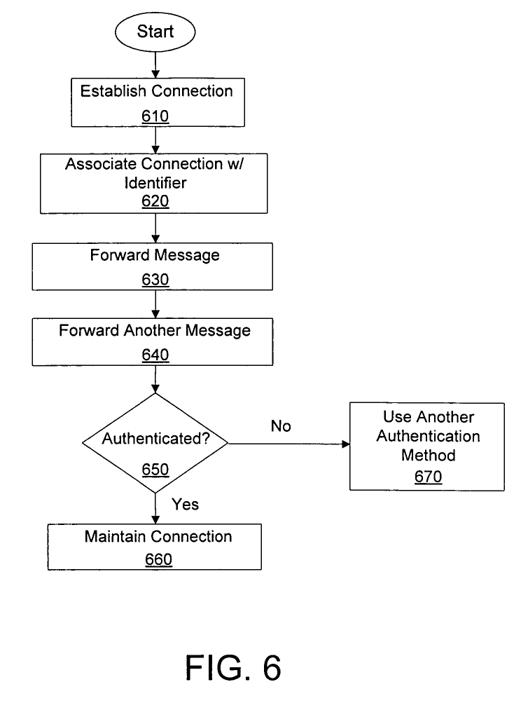

FIG. 6 is a flow chart of an example method to authenticate MNN 135 to router 130 as portrayed in FIGS. 1A and 1B. As described in the method depicted in FIG. 5, the method depicted in FIG. 6 begins with MNN 135 located within domain 110D and a point attachment to the Internet via router 110. In this example, MNN 135 wishes to maintain secure communications with CN 155.

In block 610, in one example, connection logic 410 of connection manager 400 in MNN 135 activates secure connection feature 412. Consistent with RFC 3775 and RFC 3963, in one implementation, secure connection feature 412 establishes a secure connection between MNN 135 and CN 155. This is depicted as connection 101 in FIG. 1A. As mentioned above, when describing FIG. 1A, establishing an IPSec secure connection via connection 101 includes MNN 135 and CN 155 synchronizing each other's SAD to agree on a mode of operation to maintain secure communications. In addition, bi-directional tunnels are set-up between MNN 135's current point of attachment (router 110) and its home agent (router 130).

In one implementation, secure connection feature 412 at least temporarily stores the information related to connection 101 (e.g., SAD synchronization, CN 155's network address, etc.). This information may be stored in a memory resident on or responsive to MNN 135, e.g., memory 430.

In block 620, in one example, connection logic 410 activates association feature 414 and control logic 420 activates random number generator 460. Association feature 414 obtains a random number generated by random number generator 460 and associates that random number with connection 101. The identifier may be added to the information for connection 101 that was at least temporarily stored by secure connection feature 412.

In block 630, in one example, connection logic 410 activates message feature 416. Message feature 416 generates a connection message that includes the identifier associated with connection 101. The message may also include information that specifically associates the identifier to a connection that has CN 155 as the destination of secure communications. The connection message is then forwarded to router 130, which as described above, is MNN 135's home agent on its home link.

In block 640, in one example, as depicted in FIG. 1B, MNN 135 changes its point of attachment from router 110 to router 120. Based on that change, message feature 416 generates another connection message that includes the identifier associated with connection 101. That other connection message is forwarded to router 130.

In block 650, in one example, connection manager 100 determines whether MNN 135 has been authenticated by router 130 as described in the method depicted in FIG. 5. This determination, for example, may be in the form of a response message indicating whether the identifiers matched.

In block 660, in one example, the identifiers match and secure communications are maintained via connection 101 between MNN 135 and CN 155. In one example, the process starts over should connection 101 become insecure or needs to be reestablished for some reason.

In block 670, in one example, the identifiers do not match. In this instance, MNN 135 implements other authentication procedures such as, for example, the authentication steps described in RFC 3775 or RFC 3963.

Referring again to memory 330 and 430 in FIG. 3 and FIG. 4. Memory 330 and 430 may include a wide variety of memory media including but not limited to volatile memory, non-volatile memory, flash, programmable variables or states, random access memory (RAM), read-only memory (ROM), flash, or other static or dynamic storage media.

In one example, machine-readable instructions can be provided to memory 330 or 430 from a form of machine-accessible medium. A machine-accessible medium may represent any mechanism that provides (i.e., stores and/or transmits) information or content in a form readable by a machine (e.g., an ASIC, special function controller or processor, FPGA, router, node or other hardware device). For example, a machine-accessible medium may include: ROM; RAM; magnetic disk storage media; optical storage media; flash memory devices; electrical, optical, acoustical or other form of propagated signals (e.g., carrier waves, infrared signals, digital signals); and the like.

References made in the specification to the term “responsive to” are not limited to responsiveness to only a particular feature and/or structure. A feature may also be “responsive to” another feature and/or structure and also be located within that feature and/or structure. Additionally, the term “responsive to” may also be synonymous with other terms such as “communicatively coupled to” or “operatively coupled to,” although the term is not limited in this regard.

In the previous descriptions, for the purpose of explanation, numerous specific details were set forth in order to provide an understanding of this disclosure. It will be apparent that the disclosure can be practiced without these specific details. In other instances, structures and devices were shown in block diagram form in order to avoid obscuring the disclosure.

What is claimed is:

1. In a router on a home link for a node that couples to the Internet, a method to authenticate the node comprising:
receiving a connection message from the node, the connection message to include an identifier for a secure connection between the node and another node, at least a portion of the secure connection routed over the Internet;
storing the identifier for the secure connection at the router;
receiving another connection message from the node based on the node changing its point of attachment to the Internet, the point of attachment changed from a link that couples the node to the Internet to another link that couples the node to the Internet; and
authenticating the node at the other link based on the other connection message including an identifier matching the stored identifier for the secure connection between the node and the other node.

2. A method according to claim 1, wherein the secure connection comprises the secure connection established via an Internet Protocol Security (IPSec) security association that includes the node and the other node exchanging a list of encryption standards and encryptions algorithms to use with the encryption standards and synchronizing the list to determine a mode of operation to maintain the secure connection between the nodes.

3. A method according to claim 1, wherein the secure connection comprises the secure connection established via Public Key Infrastructure (PKI) that includes exchanging a secret key for symmetric encryption of data exchanged between the nodes, the symmetric encryption to maintain the secure connection between the nodes.

4. A method according to claim 1, wherein the router, the node and the other node are coupled to different local area networks (LANs) that couple to the Internet.

5. A method according to claim 1, wherein the link and the other link are different links than the home link.

6. A method according to claim 1, wherein the secure connection includes a bidirectional tunnel with an endpoint at a router on the other link that couples the node to the Internet and another endpoint at the router on the home link.

7. In a node that couples to the Internet, a method comprising:
establishing a secure connection with another node, at least a portion of the secure connection routed over the Internet;
associating an identifier with the secure connection;
forwarding a connection message to a router on a home link for the node, the connection message to include the identifier; and
forwarding another connection message to the router on the home link based on a change in a point of attachment for the node to the Internet from one link to another link, the other connection message to include the identifier to authenticate the node to the router on the home link, authentication based on the identifier included in the connection message and the other connection message matching.

8. A method according to claim 7, wherein establishing the secure connection comprises establishing the secure connection via an Internet Protocol Security (IPSec) security association that includes the node and the other node exchanging a list of encryption standards and encryptions algorithms to use with the encryption standards and synchronizing the list to determine a mode of operation to maintain the secure connection between the nodes.

9. A method according to claim 7, wherein the secure connection comprises the secure connection established via Public Key Infrastructure (PKI) that includes exchanging a secret key for symmetric encryption of data exchanged between the nodes, the symmetric encryption to maintain the secure connection between the nodes.

10. A method according to claim 7, wherein associating the identifier with the secure connection further comprises the identifier obtained from a random number generated at the node.

11. A method according to claim 7, wherein forwarding the connection message to the router on the home link includes forwarding the connection message through another router on a link that is different than the home link.

12. A method according to claim 11, wherein the secure connection includes a bidirectional tunnel with an endpoint at that other router and another endpoint at the router on the home link.

13. A method according to claim 7, wherein the router on the home link and the node are coupled to a network that is different than the network the other node is coupled to.

14. An apparatus comprising:
a node to couple to the Internet that includes logic to:
establish a secure connection with another node, at least a portion of the secure connection routed over the Internet;
associate an identifier with the secure connection;
forward a connection message to a router on a home link for the node, the connection message to include the identifier; and
forward another connection message to the router on the home link based on a change in a point of attachment for the node to the Internet from one link to another link, the other connection message to include the identifier to authenticate the node to the router on the home link, authentication based on the identifier included in the connection message and the other connection message matching.

15. An apparatus according to claim 14, wherein the node further includes a random number generator, the logic to obtain the identifier associated with the secure connection from a random number generated by the random number generator.

16. An apparatus according to claim 14, wherein the random number generated by the random number generator comprises a 32-bit number.

17. A system comprising:
a node that couples to the Internet and includes a random number generator; and
a router on a home link for the node, the router to include logic to:
receive a connection message from the node, the connection message to include an identifier for a secure connection between the node and another node, at least a portion of the secure connection routed over the Internet, the identifier generated by the node's random number generator and associated with the secure connection based on the secure connection being established between the nodes;
store the identifier for the secure connection at the router;
receive another connection message from the node based on the node changing its point of attachment to the Internet, the point of attachment changed from a link that couples the node to the Internet to another link that couples the node to the Internet; and
authenticate the node at the other link based on the other connection message including an identifier matching the stored identifier for the secure connection between the node and the other node.

18. A system according to claim 17, wherein the secure connection comprises the secure connection established via an Internet Protocol Security (IPSec) security association that includes the node and the other node exchanging a list of encryption standards and encryptions algorithms to use with the encryption standards and synchronizing the list to determine a mode of operation to maintain the secure connection between the nodes.

19. A system according to claim 17, wherein the secure connection comprises the secure connection established via Public Key Infrastructure (PKI) that includes exchanging a secret key for symmetric encryption of data exchanged between the nodes, the symmetric encryption to maintain the secure connection between the nodes.

20. A system according to claim 17, wherein the router, the node and the other node are coupled to different local area networks (LANs) that couple to the Internet.

21. A system according to claim 17, wherein the secure connection includes a bi-directional tunnel with an endpoint at a router on the other link that couples the node to the Internet and another endpoint at the router on the home link.

22. A system according to claim 17, wherein the random number generator is to generate a 32-bit random number.

23. A machine-accessible medium comprising content, which, when executed by a machine on a home link for a node that couples to the Internet, causes the machine to:
receive a connection message from the node, the connection message to include an identifier for a secure connection between the node and another node, at least a portion of the secure connection routed over the Internet;
store the identifier for the secure connection at the machine;
receive another connection message from the node based on the node changing its point of attachment to the Internet, the point of attachment changed from a link that couples the node to the Internet to another link that couples the node to the Internet; and
authenticate the node at the other link based on the other connection message including an identifier matching the stored identifier for the secure connection between the node and the other node.

24. A machine-accessible medium according to claim 23, wherein the secure connection comprises the secure connection established via an Internet Protocol Security (IPSec) security association that includes the node and the other node exchanging a list of encryption standards and encryptions algorithms to use with the encryption standards and synchronizing the list to determine a mode of operation to maintain the secure connection between the nodes.

25. A machine-accessible medium according to claim 23, wherein the secure connection comprises the secure connection established via Public Key Infrastructure (PKI) that includes exchanging a secret key for symmetric encryption of data exchanged between the nodes, the symmetric encryption to maintain the secure connection between the nodes.

26. A machine-accessible medium comprising content, which, when executed by a node that couples to the Internet, causes the node to:
establish a secure connection with another node, at least a portion of the secure connection routed over the Internet;
associate an identifier with the secure connection;
forward a connection message to a router on a home link for the node, the connection message to include the identifier; and
forward another connection message to the router on the home link based on a change in a point of attachment for the node to the Internet from one link to another link, the other connection message to include the identifier to authenticate the node to the router on the home link, authentication based on the identifier included in the connection message and the other connection message matching.

27. A machine-accessible medium according to claim 26, wherein the secure connection comprises the secure connection established via an Internet Protocol Security (IPSec) security association that includes the node and the other node exchanging a list of encryption standards and encryptions algorithms to use with the encryption standards and synchronizing the list to determine a mode of operation to maintain the secure connection between the nodes.

28. A machine-accessible medium according to claim 26, wherein the secure connection comprises the secure connection established via Public Key Infrastructure (PKI) that includes exchanging a secret key for symmetric encryption of data exchanged between the nodes, the symmetric encryption to maintain the secure connection between the nodes.
